(19) United States
(12) Patent Application Publication
(10) Pub. No.: US 2025/0196183 A1
(43) Pub. Date: Jun. 19, 2025

(54) TREATMENT SYSTEM AND METHOD FOR TREATING WORKPIECES

(71) Applicant: Dürr Systems AG, Stuttgart (DE)

(72) Inventors: Oliver IGLAUER-ANGRIK, Stuttgart (DE); Kevin WOLL, Heilbronn (DE)

(21) Appl. No.: 18/843,965

(22) PCT Filed: Mar. 15, 2023
(86) PCT No.: PCT/DE2023/100197

§ 371 Date: Sep. 4, 2024

(30) Foreign Application Priority Data
Mar. 17, 2022 (DE) 10 2022 106 284.8

(51) Int. Cl. B05D 3/04; B05D 7/14; F26B 21/04; F26B 23/04

(52) U.S. Cl. CPC B05D 3/0413; F26B 21/04; F26B 23/04; B05D 7/14; F26B 2210/12

(57) ABSTRACT

In order to provide a treatment system (100) for treating workpieces (102) that is of a simple and compact construction and enables an efficient treatment of workpieces, it is proposed that the treatment system (100) comprises the following: a treatment space (110) which serves to receive one or a plurality of workpieces (102) and in which a treatment procedure is able to be carried out; and one or a plurality of recirculating air units (118) by means of which a recirculating airflow guided through the treatment space (110) is able to be generated, wherein the one or the plurality of recirculating air units (118) comprises/comprise in each case one or a plurality of electric heating devices (122).

### RELATED APPLICATION

This application is a national phase of international application No. PCT/DE2023/100197 filed on Mar. 15, 2023, and claims the benefit of German application No. 10 2022 106 284.8 filed on Mar. 17, 2022, which are incorporated herein by reference in their entirety and for all purposes.

### FIELD OF DISCLOSURE

The present disclosure relates to a treatment system for treating workpieces, in particular to a dryer for drying coated vehicle bodies. The treatment system is thus in particular a constituent part of a painting system for painting vehicle bodies.

### BACKGROUND

To date, dryers are in most instances centrally heated. In particular, burner systems, gas turbines or other gas-fired systems are considered for this. For gas-fired systems, the central heating is often the concept of choice due to the flexibility, closed-loop controllability, pre-assembly of the fan units and savings in terms of electricity consumption, but can also be associated with disadvantages when setting up external supply apparatuses and connecting them by way of gas ducts.

### SUMMARY

The present disclosure is based on the object of providing a treatment system which is of a simple and compact construction and enables an efficient operation.

This object is achieved according to examples disclosed herein by a treatment system as claimed in claim 1.

The treatment system serves to treat workpieces. The treatment system is in particular a dryer for drying vehicle bodies.

The treatment system preferably comprises the following:
a treatment space which serves to receive one or a plurality of workpieces and in which a treatment procedure is able to be carried out; and
one or a plurality of recirculating air units by means of which a recirculating airflow guided through the treatment space is able to be generated, wherein the one or the plurality of recirculating air units comprises/comprise in each case one or a plurality of electric heating devices.

Due to the fact that the treatment system preferably comprises one or a plurality of recirculating air units having in each case one or a plurality of electric heating devices, the treatment system can preferably be of a simple and compact construction. In particular, savings can preferably be made in terms of complex duct systems in comparison to centrally gas-fired systems.

The treatment system preferably comprises a plurality of electric heating devices which serve in particular to heat different treatment space portions. The treatment system thus preferably comprises a decentralized heating system. As a result, the interfaces and thus the complexity in terms of engineering and on the construction site can preferably be minimized.

The one or the plurality of heating devices preferably comprises/comprise in each case one or a plurality of electric heating registers. As a result, the one or the plurality of heating devices can preferably be rapidly controllable in a closed loop and have a minor pressure loss.

It can be advantageous when the treatment space comprises a plurality of treatment space portions, wherein each treatment space portion is assigned a separate recirculating air unit.

The treatment system preferably comprises a conveyor device by means of which the workpieces are able to be conveyed along a conveying direction through the treatment space.

The treatment space portions are preferably disposed in succession along the conveying direction of the conveyor device of the treatment system.

The workpieces are preferably able to be conveyed through the treatment space in a transverse alignment, wherein in the transverse alignment a longitudinal axis, in particular a vehicle longitudinal axis, of the workpieces is aligned transversely, in particular at least approximately perpendicularly, to the conveying direction and/or at least approximately horizontally.

It can be favorable when each recirculating air unit comprises the following: a fan for driving the recirculating airflow in the respective recirculating air unit; an electric heating device for heating the recirculating airflow;
one or a plurality of supply devices for supplying the heated recirculating airflow to the treatment space;
one or a plurality of return ducts for returning the recirculating airflow from the treatment space to the fan.

The recirculating airflow is preferably able to be driven by means of the fan in such a manner that it successively flows through the electric heating device, a distributor space, a treatment space portion of the treatment space, a return duct and an induction space, in particular in this sequence, before making its way to the fan again.

In terms of a flow direction of the recirculating airflow, the electric heating device is preferably disposed downstream of the fan and/or upstream of a distributor space. The distributor space is directly contiguous to the treatment space, for example, and serves to distribute the recirculating airflow to a plurality of supply devices, in particular nozzles. The recirculating airflow is able to be introduced, preferably in a directed manner, into the treatment space by way of the supply devices, in particular nozzles.

It can be advantageous when each recirculating air unit comprises a fan for driving the recirculating airflow in the respective recirculating air unit and an electric heating device for heating the recirculating airflow, wherein an induction space is preferably provided upstream of the fan.

It can be favorable when the induction space extends, in a horizontal transverse direction of the treatment system, which is in particular perpendicular to a conveying direction, over at least approximately 50%, in particular at least approximately 100%, preferably at least approximately 200%, of a horizontal extent of an impeller of the fan.

Alternatively or additionally thereto, it can be provided that the induction space is disposed between the treatment space and the fan, in particular in terms of a horizontal transverse direction of the treatment system that runs perpendicularly to a conveying direction.

Furthermore alternatively or additionally thereto, it can be provided that the induction space is disposed, in the vertical direction, so as to be at least approximately level with an impeller of the fan.

In a further design embodiment or a refinement of examples disclosed herein, it can be alternatively or additionally provided that each recirculating air unit comprises a fan for driving the recirculating airflow in the respective recirculating air unit and an electric heating device for heating the recirculating airflow, wherein an ejection region and/or a homogenization region are/is preferably provided downstream of the fan.

It can be favorable when the ejection region and/or the homogenization region extend/extends, in the vertical direction, over at least approximately 50%, in particular at least approximately 100%, in particular at least approximately 200%, of a vertical extent of an impeller of the fan (120).

Alternatively or additionally thereto, it can be favorable when the ejection region and/or the homogenization region are/is disposed directly above the fan and/or an induction space.

Furthermore, alternatively or additionally thereto, it can be provided that the ejection region and/or the homogenization region are/is disposed, in the horizontal direction, so as to be at least approximately level with the one or the plurality of electric heating devices.

It is preferably provided that the fan is a radial fan, wherein a rotation axis of an impeller of the radial fan is preferably aligned so as to be at least approximately horizontal and/or at least approximately perpendicular to a conveying direction of the treatment system.

It can be provided that the one or the plurality of return ducts runs/run below the treatment space, in particular in a floor wall assembly of the treatment system that delimits the treatment space toward the bottom.

It can be favorable when one or a plurality of the recirculating air units has/have in each case one or a plurality of supply ducts by means of which recirculating air which has been heated by means of the electric heating device is able to be guided from a side of the treatment space on which the electric heating device is disposed to a further side of the treatment space from where it is able to be directed into the treatment space.

One or a plurality of supply ducts can for example fluidically connect a distributor space, which is disposed directly downstream of the electric heating device, to a further distributor space that is disposed on an opposite side of the treatment space.

Alternatively or additionally thereto, it can be provided that one or a plurality of supply ducts fluidically connect a distributor space, which is disposed directly downstream of the electric heating device, to one or a plurality of supply devices, in particular nozzles, in a floor wall assembly of the treatment system, for example. As a result, door sill regions, or other parts of the workpieces that are rich in mass, can in particular be targeted with a flow of recirculating air.

In one design embodiment of examples disclosed herein, it can be provided that one or a plurality of the recirculating air units comprises/comprise in each case a plurality of electric heating devices.

It can be particularly advantageous when the one or the plurality of electric heating devices is/are the only devices that serve in particular primarily to heat the recirculating airflow.

It can be favorable when the one or the plurality of recirculating air units, in particular all of the recirculating air units, is/are disposed so as to be laterally contiguous to the treatment space. In particular, a scaffold for high-level assembly work can preferably be dispensed with in this instance.

The one or the plurality of recirculating air units is/are preferably accessible completely at ground level, in particular for assembly and/or maintenance work.

In this instance, the treatment system preferably does not require any complex scaffolding.

The examples disclosed herein are furthermore based on the object of providing a method which, while using a treatment system of simple and compact design, enables efficient operation of the latter.

This object is achieved according to examples disclosed herein by a method as claimed in the independent method claim.

The method is in particular a method for treating workpieces, in particular for drying vehicle bodies.

The method preferably comprises the following:
supplying one or a plurality of workpieces to a treatment space of a treatment system, in particular a treatment system according to examples disclosed herein;
heating the one or the plurality of workpieces by means of one or a plurality of recirculating airflows, wherein the one or the plurality of recirculating airflows is/are generated by means of one or a plurality of recirculating air units;
heating the one or the plurality of recirculating airflows by means of one or a plurality of electric heating devices.

The method preferably has one or more of the features and/or advantages described in the context of the treatment system.

Furthermore, the treatment system preferably has one or more of the features and/or advantages described in the context of the method.

It can be favorable when the treatment space is supplied with conditioned fresh air and this fresh air is subsequently circulated as a recirculating airflow in one or a plurality of recirculating air units, wherein supplying heat in the recirculating air units is performed exclusively by electric heating.

The conditioned fresh air is in particular supplied by way of one or two airlocks at one or both ends of the treatment space.

The treatment system furthermore preferably comprises a discharge device for discharging exhaust air. The exhaust air is in particular discharged from a treatment space portion which is disposed so as to be centric in terms of the conveying direction, for example.

It can be advantageous when the exhaust air is supplied to a cleaning device, for example a regenerative thermal oxidation device (RTO) so as to remove contaminations contained in the exhaust air. The cleaning device is preferably disposed outside a building in which the treatment system is installed.

In one design embodiment of examples disclosed herein, it can be provided that the one or the plurality of recirculating airflows is/are supplied to one or a plurality of fans of the one or a plurality of recirculating air units in an at least approximately horizontal direction.

Alternatively or additionally thereto, it can be provided that the one or the plurality of recirculating airflows is/are discharged from the one or the plurality of fans upward in an at least approximately vertical direction.

Furthermore, it can be provided alternatively or additionally thereto that the one or the plurality of recirculating airflows is/are deflected in a spatial region disposed above the one or the plurality of fans, and/or is/are in particular supplied to the one or the plurality of electric heating devices in an at least approximately horizontal direction.

Furthermore, the treatment system and/or the method can preferably have one or more of the features and/or advantages described hereunder:

It can optionally be provided that one or a plurality of directing elements for the targeted guiding of the flow, and/or influencing of the flow, is/are disposed in a spatial region which is directly contiguous to a fan and in particular opens into a heating device.

An at least approximately homogenous inflow to the heating device is preferably obtainable by means of one or a plurality of directing elements.

Furthermore, alternatively or additionally, one or a plurality of cover elements which partially cover an inflow cross-sectional area of the heating device can be provided. This can likewise serve to facilitate a more homogenous flow.

One or a plurality of cover elements can be designed as a perforated metal sheet, for example, so as to cause a local restriction of the flow.

The one or the plurality of cover elements are thus preferably restrictor elements.

It can be favorable when the one or the plurality of heating devices, in particular heating registers, is/are sized in such a manner that it/they is/are able to be retrieved from a receptacle for the respective heating device in a direction running at least approximately parallel to the conveying direction, in particular without requiring disassembling of other components of the treatment system.

For example, it can be provided that each recirculating air unit is assigned a plurality of treatment space portions but only extends over one of the treatment space portions in such a way that one or a plurality of treatment space portions disposed adjacent to one another enable a void for servicing and/or repairing the heating device that proceeds from the heating device along the conveying direction.

In particular, one or a plurality of electric heating registers are sized in such a way that their insertion depth falls short of an extent of a treatment space along the conveying direction. The disposal of the heating devices is in particular chosen in such a way that a treatment space portion adjacent to each heating device is not occupied by a heating device. The disassembling can then take place in or counter to the conveying direction (running direction through the dryer). As a result, a required reserved space extending perpendicularly to the conveying direction onto the disassembling space of the fan is preferably reduced.

For example, heat exchangers can be provided for recovering heat discharged by way of the exhaust air. These heat exchangers transmit the heat to a flow of fresh air to be supplied, for example. As a result, partial pre-heating of the flow of fresh air can preferably be achieved in particular.

Alternatively thereto, heat recovery can preferably be implemented by way of waste heat boilers.

The one or the plurality of recirculating air units is/are preferably able to be preassembled conjointly with the assigned one treatment space portion, or conjointly with the assigned plurality of treatment space portions, and able to be transported as a unit to a final assembly site. As a result, media interfaces can preferably be dispensed with; in this instance, only one electrical connection is required.

One or a plurality of, in particular all, electrically operated heating components such as, inter alia, fresh air heat exchangers and/or fresh air heaters, can preferably be supplied with a medium voltage of, for example, at least approximately 3 kV and/or at most approximately 8 kV, in particular 4160 V to 6600 V, in particular instead of the customary 400 V. One or a plurality of medium-voltage heating elements can be provided for this purpose, for example. This may require special heating elements associated with corresponding additional costs but preferably offers great savings potential in terms of peripherals, i.e. with regard to connectors, cables, etc. Moreover, a substantially lower factor of voltage transformation from the grid is preferably required as a result, which inter alia reduces the transformer station with a view to lower investment costs and saves space. Moreover, the connection to an electrically operated heating component with a medium voltage of this type is preferably associated with significantly lower cable diameters.

Further preferred features and/or advantages of examples disclosed herein are the subject matter of the description hereunder and of the illustration of exemplary embodiments in the drawing.

### BRIEF DESCRIPTION OF THE DRAWINGS

FIG. 1 shows a schematic vertical cross section through an embodiment of a treatment system;

FIG. 2 shows an enlarged illustration of a recirculating air unit of the treatment system from FIG. 1;

FIG. 3 shows a schematic perspective illustration of a heating device of the recirculating air unit of the treatment system from FIG. 1; and

FIG. 4 shows a vertical cross section through a region of a treatment space of an alternative design embodiment of a treatment system, said region facing away from the recirculating air unit.

Identical or functionally equivalent elements are provided with the same reference signs in all of the figures.

### DETAILED DESCRIPTION OF THE DRAWINGS

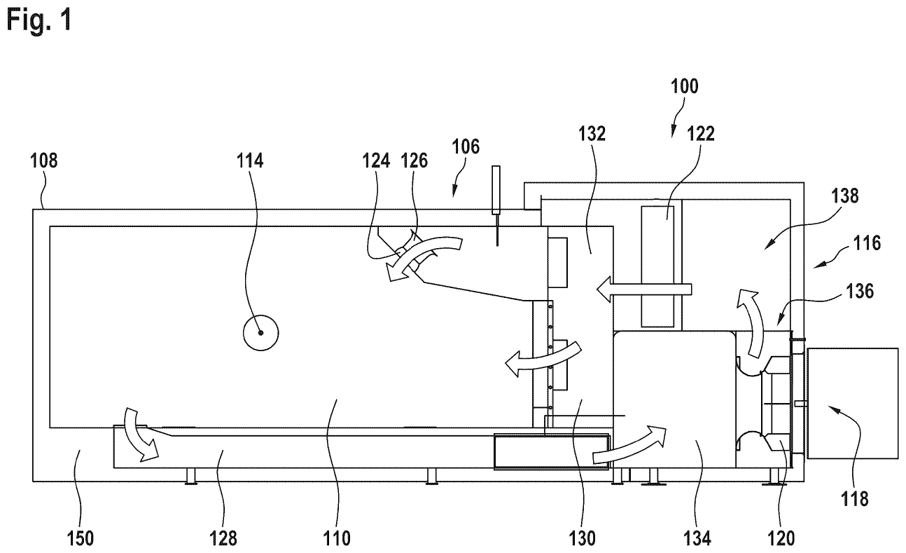

An embodiment of a treatment system, which is illustrated in FIGS. 1 to 3 and denoted by the reference sign 100 as an entity, serves to treat workpiece 102, in particular vehicle bodies 104. The treatment system 100 is in particular a dryer 106 for drying previously coated vehicle bodies 104.

The treatment system 100 comprises a housing 108 which surrounds a treatment space 110. The treatment space 110 serves to receive workpieces 102 for treating the latter.

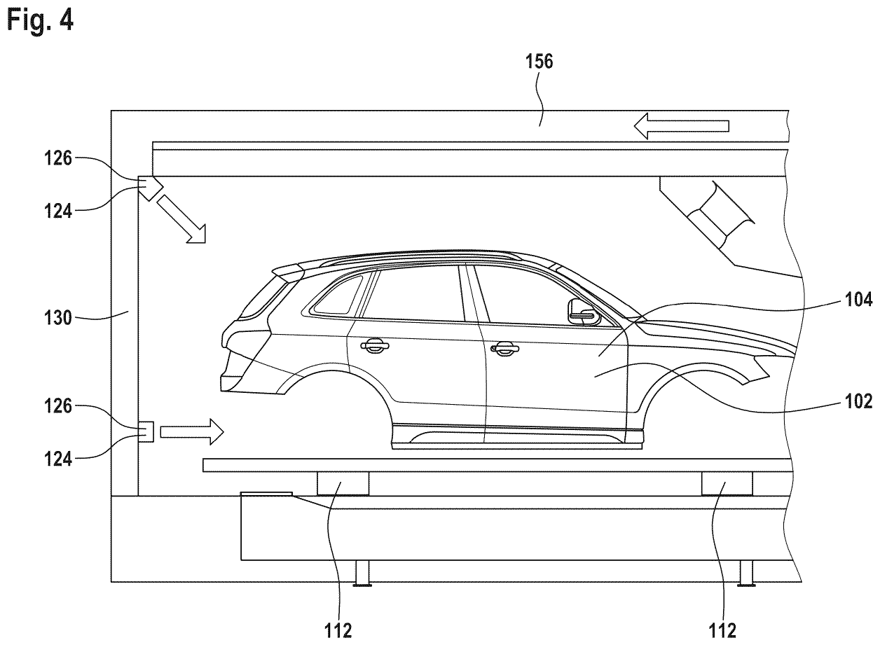

The workpieces 102 are in particular able to be conveyed along a conveying direction 114 through the treatment space 110 by means of a conveyor device 112 of the treatment system 100 (only illustrated in FIG. 4) and able to be impinged with heated recirculating air in the process.

The treatment system 100 comprises an air guide 116 which comprises in particular one or a plurality of recirculating air units 118. A volumetric flow of recirculating air is able to be guided through the treatment space 110 multiple times by means of the one or the plurality of recirculating air units 118.

Each recirculating air unit 118 preferably comprises a fan 120 for driving the recirculating airflow, an electric heating device 122 for heating the recirculating airflow, and one or a plurality of supply devices 126, designed for example as nozzles 124, for supplying the recirculating airflow to the treatment space 110, and one or a plurality of return ducts 128 for discharging the recirculating airflow from the treatment space 110.

A distributor space 130, which serves to distribute the heated recirculating airflow to the supply devices 126, is preferably disposed between the heating device 122 and the one or the plurality of supply devices 126. The distributor space 130 is preferably accessible to personnel and also serves as a maintenance region 132 for carrying out cleaning and/or maintenance work within the respective recirculating air unit 118.

The fan 120 is preferably a freely running installed fan.

The fan 120 is preferably a radial fan. However, in an embodiment not illustrated, it can alternatively also be provided that the fan 120 is a longitudinal flow fan (axial fan).

An induction space 134 which in particular extends transversely, preferably perpendicularly, to the conveying direction 114 over a depth which corresponds at least approximately to a diameter of an impeller of the fan 120 is preferably provided upstream of the fan 120. An efficient induction perpendicular to the conveying direction 114 is possible as a result.

The induction space 134 is preferably disposed between the treatment space 110 and the fan 120, in particular in terms of a horizontal transverse direction of the treatment system 100 that runs perpendicularly to the conveying direction 114. An ejection region 136 of the fan 120 is preferably formed above the fan 120. In this way, the fan 120 preferably inducts in the horizontal direction and ejects upward in the vertical direction.

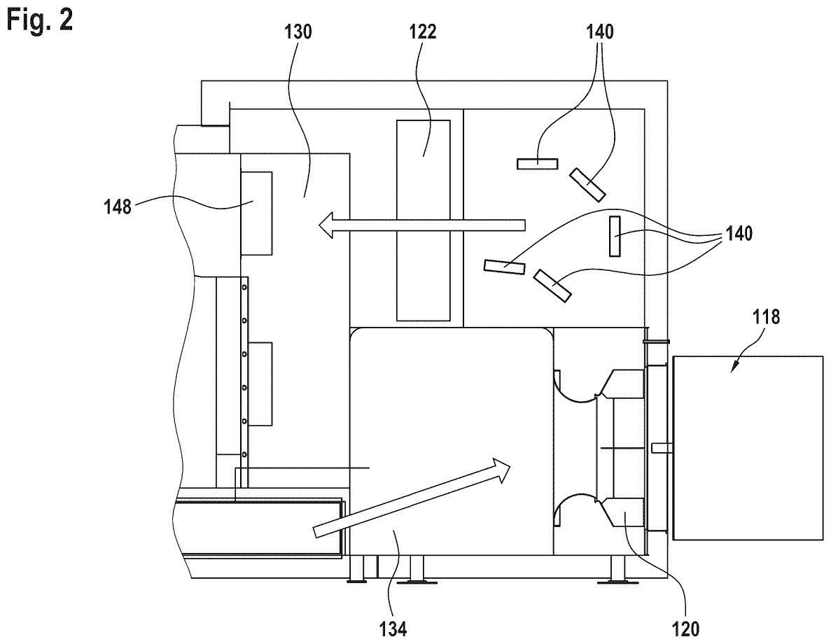

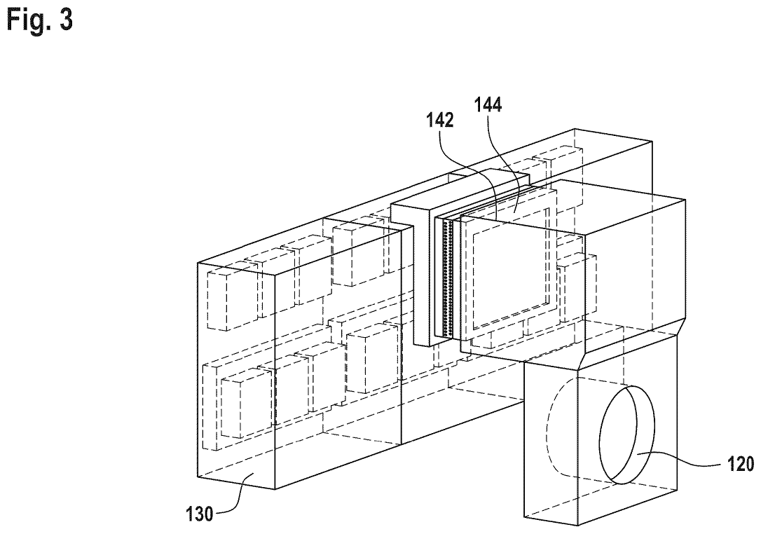

A homogenization region 138, which serves to facilitate an as homogenous supply of the recirculating airflow to the heating device 122 as possible, preferably adjoins the ejection region 138. As can be derived in particular from FIGS. 2 and 3, one or a plurality of directing elements 140, one or a plurality of cover elements 142 and/or one or a plurality of restrictor elements 144, for example frame elements, perforated metal sheets, or other components which contribute to a uniform inflow to and/or flow through the heating device 120, can be provided for further homogenizing the inflow to the heating device 122.

The one or the plurality of directing elements 140, the one or the plurality of cover elements 142 and/or the one or the plurality of restrictor elements 144 can be screwed or otherwise fixed to support elements or other constituent parts of the air guide 116, for example. An interchangeable fixing can in particular be provided in order to be able to replace the element or elements for further optimization or for maintenance.

The heating device 120 is or comprises in particular a heating register 146 which is able to be passed through by the flow of recirculating air, wherein electrical resistance heating elements of the heating device 120 in particular generate heat and dispense it to the recirculating airflow.

One or a plurality of filter elements 148 is/are preferably disposed downstream of the heating device 120, in particular in the distributor space 130 or adjoining the latter, for example directly upstream of the one or the plurality of supply devices 126. The one or the plurality of filter elements 148 serves/serve in particular to separate contaminations from the recirculating airflow prior to the latter being supplied to the treatment space 110.

The one or the plurality of return ducts 128 are disposed, in particular integrated, in a floor wall assembly 150 of the housing 108 of the treatment system 100, for example. The one or the plurality of return ducts 128 preferably extends/extend over more than half of a width of the treatment space in such a way that suctioning of the recirculating air is in particular performed at least approximately on a side of the treatment space 110 that lies opposite the supply devices 126.

The embodiment of a treatment system 100 illustrated in FIGS. 1 to 3 functions as follows:

First, one or a plurality of workpieces 102 is/are incorporated into the treatment space 100 along the conveying direction 114 by means of the conveyor device 112. The workpieces 102 are then impinged with heated recirculating air from the one or the plurality of recirculating air units 118 and dried as a result, for example.

The recirculating air is for this purpose guided in a circle by means of the fan 120, and in the process proceeding from the fan 120 flows successively through the homogenization region 138, the heating device 122, the distributor space 130, optionally one or a plurality of filter elements 148, the one or the plurality of supply devices 126, the treatment space 110 and the one or the plurality of return ducts 128. Finally, the recirculating air makes its way back to the fan 120 by way of the induction space 134.

The heat required for carrying out the treatment procedure is generated by means of the heating device 122. For this purpose, the heating device 122 is or comprises an electric heating register 146 which dispenses electrically generated heat to the recirculating airflow when the latter flows through said heating register 146.

In this way, the heating device 122 generates heat where it is required. An additional, different heat source, which is disposed outside the respective recirculating air unit 118 and is thus expansive, is preferably able to be dispensed with as a result. Owing to this fact, the recirculating air unit 118 can be of a particularly compact design. In particular, complex line systems for heating gas or other heat transfer media can be dispensed with.

It can be provided that each recirculating air unit 118 comprises a single heating device 122.

Alternatively thereto, it can be provided that each recirculating air unit 118 comprises a plurality of heating devices 122.

As can be seen in particular by means of FIG. 4, it can be provided that the recirculating airflow is not supplied to the treatment space 110 completely on one side but that one distributor space 130 is in each case disposed on either side, for example. In this instance, the supply of heated recirculating air is performed in particular on the one hand as in the embodiment according to FIGS. 1 to 3 and on the other hand according to FIG. 4, on the opposite side of the treatment space 110. For this purpose, the opposite distributor space 130 is preferably supplied with heated recirculating air by means of a supply duct 156.

In further alternative embodiments of treatment systems 100, one or a plurality of supply ducts 156 can furthermore alternatively or additionally be disposed in the floor wall assembly 150 and, for example, lead to supply devices 126 which serve to impinge mass-rich components of the workpieces 102, for example door sills or support structures of a vehicle body 104. For example, it can be provided that one or a plurality of supply devices 126 are disposed in the region of a dryer rear wall and/or in the floor region and extend along two vehicle door sills of the workpiece 102, for example.

In this way, overall more uniform heating of the workpiece 102 can preferably be implemented, whereby a compact construction and efficient operation of the system can be derived as a result of the one or the plurality of electric heating devices 122.

### LIST OF REFERENCE SIGNS

100 Treatment system
102 Workpiece
104 Vehicle body
106 Dryer
108 Housing
110 Treatment space
112 Conveyor device
114 Conveying direction
116 Air guide
118 Recirculating air unit
120 Fan
122 Heating device
124 Nozzle
126 Supply device
128 Return duct
130 Distributor space
132 Maintenance region
134 Induction space
136 Ejection region
138 Homogenization region
140 Directing element
142 Cover element
144 Restrictor element
146 Heating register
148 Filter element
150 Floor wall assembly
156 Supply duct

1. A treatment system for treating workpieces, optionally for drying vehicle bodies, wherein the treatment system comprises the following:
a treatment space which serves to receive one or a plurality of workpieces and in which a treatment procedure is able to be carried out; and
one or a plurality of recirculating air units by which a recirculating airflow guided through the treatment space is able to be generated, wherein the one or the plurality of recirculating air units include in each case one or a plurality of electric heating devices.

2. The treatment system as claimed in claim 1, wherein the treatment space includes a plurality of treatment space portions, wherein each treatment space portion is assigned a separate recirculating air unit.

3. The treatment system as claimed in claim 1, wherein each recirculating air unit includes the following:
a fan for driving the recirculating airflow in the respective recirculating air unit;
an electric heating device for heating the recirculating airflow;
one or a plurality of supply devices for supplying the heated recirculating airflow to the treatment space;
one or a plurality of return ducts for returning the recirculating airflow from the treatment space to the fan.

4. The treatment system as claimed in claim 3, wherein in terms of a flow direction of the recirculating airflow the electric heating device is disposed downstream of the fan and upstream of a distributor space, wherein the distributor space is contiguous to the treatment space and serves to distribute the recirculating airflow to a plurality of supply devices, in particular nozzles.

5. The treatment system as claimed in claim 1, wherein each recirculating air unit includes a fan for driving the recirculating airflow in the respective recirculating air unit and an electric heating device for heating the recirculating airflow, wherein an induction space is provided upstream of the fan, wherein
a) the induction space extends, in a horizontal transverse direction of the treatment system, which is optionally perpendicular to a conveying direction, over at least approximately 50%, optionally at least approximately 100%, preferably at least approximately 200%, of a horizontal extent of an impeller of the fan; and/or
b) the induction space is disposed between the treatment space and the fan, optionally in terms of a horizontal transverse direction of the treatment system that runs perpendicularly to a conveying direction; and/or
c) the induction space is disposed, in the vertical direction, so as to be at least approximately level with an impeller of the fan.

6. The treatment system as claimed in claim 1, wherein each recirculating air unit includes a fan for driving the recirculating airflow in the respective recirculating air unit and an electric heating device for heating the recirculating airflow, wherein an ejection region and/or a homogenization region are provided downstream of the fan, wherein
a) the ejection region and/or the homogenization region extend, in the vertical direction, over at least approximately 50%, optionally at least approximately 100%, preferably at least approximately 200%, of a vertical extent of an impeller of the fan; and/or
b) the ejection region and/or the homogenization region are disposed directly above the fan and/or an induction space; and/or
c) the ejection region and/or the homogenization region are/is disposed, in the horizontal direction, so as to be at least approximately level with the one or the plurality of electric heating devices.

7. The treatment system as claimed in claim 1, wherein the fan is a radial fan, wherein a rotation axis of an impeller of the radial fan is aligned so as to be at least approximately horizontal and/or at least approximately perpendicular to a conveying direction of the treatment system.

8. The treatment system as claimed in claim 1, wherein each recirculating air unit includes the following:
a fan for driving the recirculating airflow in the respective recirculating air unit;
an electric heating device for heating the recirculating airflow;
one or a plurality of supply devices for supplying the heated recirculating airflow to the treatment space;
one or a plurality of return ducts for returning the recirculating airflow from the treatment space to the fan; and
wherein the one or the plurality of return ducts run below the treatment space, optionally in a floor wall assembly of the treatment system that delimits the treatment space toward the bottom.

9. The treatment system as claimed in claim 1, wherein each recirculating air unit the following:
a fan for driving the recirculating airflow in the respective recirculating air unit;
an electric heating device for heating the recirculating airflow;
one or a plurality of supply devices for supplying the heated recirculating airflow to the treatment space;
one or a plurality of return ducts for returning the recirculating airflow from the treatment space to the fan; and
wherein one or a plurality of the recirculating air units has/have in each case one or a plurality of supply ducts by which recirculating air which has been heated by of the electric heating device is able to be guided from a side of the treatment space on which the electric heating device is disposed to a further side of the treatment space from where it is able to be directed into the treatment space.

10. The treatment system as claimed in claim 9, wherein one or a plurality of the supply ducts fluidically connect a distributor space, which is disposed directly downstream of the electric heating device, to a further distributor space that is disposed on an opposite side of the treatment space.

11. The treatment system as claimed in claim 1, wherein the one or the plurality of electric heating devices are the only devices for heating the recirculating airflow.

12. The treatment system as claimed in claim 1, wherein the one or the plurality of recirculating air units are disposed so as to be laterally contiguous to the treatment space and/or are accessible completely at ground level, in particular for assembly and/or maintenance work.

13. A method for treating workpieces, optionally for drying vehicle bodies, wherein the method comprises the following:
supplying one or a plurality of workpieces to a treatment space of a treatment system, optionally a treatment system as claimed in claim 1;
heating the one or the plurality of workpieces by one or a plurality of recirculating airflows, wherein the one or the plurality of recirculating airflows are generated by one or a plurality of recirculating air units; and
heating the one or the plurality of recirculating airflows by one or a plurality of electric heating devices.

14. The method as claimed in claim 13, wherein the treatment space is supplied with conditioned fresh air and the fresh air is circulated as a recirculating airflow in one or a plurality of recirculating air units, wherein supplying heat in the recirculating air units is performed by electric heating.

15. The method as claimed in claim 13, wherein the one or the plurality of recirculating airflows
a) are supplied to one or a plurality of fans of the one or the plurality of recirculating air units in an at least approximately horizontal direction;
b) are discharged from the one or the plurality of fans upward in an at least approximately vertical direction; and/or
c) are deflected in a spatial region disposed above the one or the plurality of fans, and are optionally supplied to the one or the plurality of electric heating devices in an at least approximately horizontal direction.
